(19) United States
(12) Patent Application Publication
(10) Pub. No.: US 2015/0154701 A1
(43) Pub. Date: Jun. 4, 2015

(54) PROVIDING GUARANTEED EXECUTION OF MARKET SPREADS

(71) Applicant: GX2 Systems, LLC, Chicago, IL (US)

(72) Inventors: David W. Jaberg, Glencoe, IL (US); Anton Kryukov, Buffalo Grove, IL (US); Jason R. Nazarof, Chicago, IL (US); Darek Poczobut-Potchebout, Northbrook, IL (US)

(21) Appl. No.: 14/555,376

(22) Filed: Nov. 26, 2014

Related U.S. Application Data
(60) Provisional application No. 61/909,969, filed on Nov. 27, 2013.

(51) Int. Cl. G06Q 40/04

(52) U.S. Cl. CPC G06Q 40/04

(57) ABSTRACT

The described technology creates an execution risk transfer (“ERT”) by transferring the risk of fulfilling a spread trade from a user or trader to another entity such as a trading firm or another user account. The described technology delivers or reports electronic market fills, proxy fills representing synthetic price risk transfers, or other instruments to users, which are executed at a desired spread level. The risk associated with the execution of the spread is managed by the technology and reduced at the electronic market(s), internal transfers, or other methods of risk reduction.

### CROSS-REFERENCE TO RELATED APPLICATIONS

This application claims priority to U.S. Provisional Application Ser. No. 61/909,969 filed Nov. 27, 2013, which is incorporated herein by reference in its entirety for all purposes.

### BACKGROUND

In trading, a spread trade is the purchase or sale of at least one instrument (e.g., a soybean oil future contract) and the purchase or sale of at least one different instrument (e.g., a soybean future contract) as a strategy. Spreads may have two legs like the soybean oil future contract purchase and the soybean future contract sale, or have more than two legs (e.g., one purchase leg and three sale legs). Spread trades are executed to yield an overall net position whose value, called the spread or spread-level, depends on the difference between the prices of the legs, relative weighting of the legs, or other mathematical relationships. Spread trades are executed to attempt to profit from the widening or narrowing of the spread, rather than from movement in the prices of each of the legs directly. Spreads are either “bought” or “sold” depending on whether the trade will profit from the widening or narrowing of the spread.

Some common spreads are priced and traded as a unit on financial exchanges rather than as individual legs, thus ensuring simultaneous execution and eliminating the execution risk of one leg executing while the other leg fails. However, some spreads are not offered as a unit or can only be traded using individual legs because the legs are resident on different exchanges or markets. A trader who trades spreads executes each leg of the spread manually (e.g., entering each leg order sequentially when market conditions meet a pricing criteria), by an automated execution platform, or by an algorithm-driven execution platform that attempts to execute all of the legs as efficiently and accurately as possible once the target pricing conditions are met.

### BRIEF DESCRIPTION OF THE DRAWINGS

Embodiments of the present technology will be described and explained through the use of the accompanying drawings in which:

FIG. 1 is a block diagram of a basic and suitable computer that may employ aspects of the described technology.

FIG. 2 is a block diagram illustrating a simple, yet suitable, system in which aspects of the described technology may operate in a networked computer environment.

FIG. 3 is a schematic diagram of components within various embodiments of the present system.

FIG. 4A is an example flow diagram illustrating aspects of some embodiments of the technology.

FIGS. 4B, 5A and 5B show tables or display screens for representative data that may be generated by various embodiments of the system.

FIGS. 6A, 6B, 6C, 7A, 7B, 7C, 7D, 7E and 7F are examples of various display screens that may be used by one or more embodiments of the present technology.

FIGS. 8-9 are block diagrams illustrating various components of various system configurations of some embodiments of the present technology.

FIG. 10 illustrates an example of a quick action interface that may be used in accordance with one or more embodiments of the present technology.

While the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the invention as defined by the appended claims. Finally, the headings provided herein are for convenience and do not necessarily affect the scope or interpretation of the described technology.

### DETAILED DESCRIPTION

The inventors have recognized that current technology lacks an effective method, system, GUI, and/or device to mitigate a trader's execution risk. For instance, given the multiple execution requirements of a spread trade, a trader can miss the target price on one of the legs, which can result in sub-optimal pricing of the overall spread (“slippage”), or not get an order filled on all of the target legs (i.e., getting “legged out”), and end up with a spread that is not hedged properly. This can create greater risk and volatility in the resulting position for the trader. In such a case, the trader may have to reverse out of all the filled legs (typically at a loss) and start over, manage slippage by executing the missing leg at a different price (e.g., the spread is filled but not at the target price), attempt to fill a missed leg with another substitute contract that is likely not as correlated to the spread components as the original target legs, and/or keep the unbalanced position as-is. In all cases the execution risk may result in a trade that is not modeled as part of the strategy.

As described in detail below, various embodiments of a trading system and technology “guarantees” spread level fills by transferring some or all of the risk of multi-legged spreads from a trader to a different trader, another account, the trading firm, or another entity entirely. The described technology “guarantees” a trader's spread in the sense that it provides a specific, guaranteed price, guaranteed price range, or likely executed price to the user while providing a holistic transfer of risk to the system, but separate legs of the spread are not executed until the system determines a selected or “best” time to fulfill each of the spread's legs. The trader's execution risk may, therefore, be partially or fully placed on the described technology and not on the trader. The described system provides functionality such as this and as described below in an automated system, functionality which could not be performed (or preformed in any commercially valuable way) manually.

Note that the terms “technology” and “system” are occasionally used interchangeably herein, and refer to a “GX2” system as shown in the Figures. While the term “trader” is used generally herein, those of ordinary skill in the relevant art will recognize that any user may employ the present system. Furthermore, some embodiments of the present system are applicable to trading not only, for example commodities, but any instrument capable of being traded on an electronic market.

The term “fills” includes a reported transaction from an exchange, as well as other fills, such as proxy fills performed by the system described in detail herein. While the various embodiments of the present technology are generally described as a trader interacting with the system via a GUI (e.g., receiving orders or other data regarding a spread via the GUI), some embodiments of the technology can alternatively or additionally permit any user or external system to access the technology using an application programming interface (API). The technology not only allows multiple clients to access a centralized server to execute “risk proxy” trades, but also permits access to the centralized server by other computers (including other via APIs).

Some embodiments of the described technology include a system, method, GUI and/or device for executing spreads for multiproduct (e.g., soybean and soybean oil futures), multi-leg, customized, spread relationships. The technology, in accordance with various embodiments, can execute a trader's order at the desired spread level, which is in balance (meaning the intended weighting of one leg compared to the other legs), and not legged out. In some embodiments, the system can compute and present a variety of fulfillment values that may be associated with different pricing structures. For example, the system may be able to generate a fulfillment value at which the system will likely be able to execute a spread order, but does not guarantee the fulfillment value. The system may also generate a collar for the fulfillment value which limits the upside or downside variations in market execution. Similarly, the system may be able to generate a guaranteed fulfillment value which shifts all risk to the trading platform to cover variations in the executed market orders.

A trading client, with which the trader interacts via a GUI, places spread orders using internal risk market proxies (e.g., representations of market orders). To the trader, this appears as a dynamic, real-time display of electronic market data, with which the trader can interact to place orders that are immediately fulfilled, even though the actual fulfillment of those orders is possibly done later, and any risk of slippage, etc. may be borne (partially or fully) by the system.

To increase precision and granularity when calculating spreads, one or more risk proxy markets may associate a decimalized version of an asset with the fractional notation used in the market to represent that asset. These risk proxy markets are then presented or delivered to the trader via the GUI or other electronic means (e.g., an API) so that these markets may be used to instantly or nearly instantly price traders' desired or custom-created, multi-legged spreads. As described herein, some embodiments of the technology fill the desired spread when criteria such as price, liquidity and stability are met.

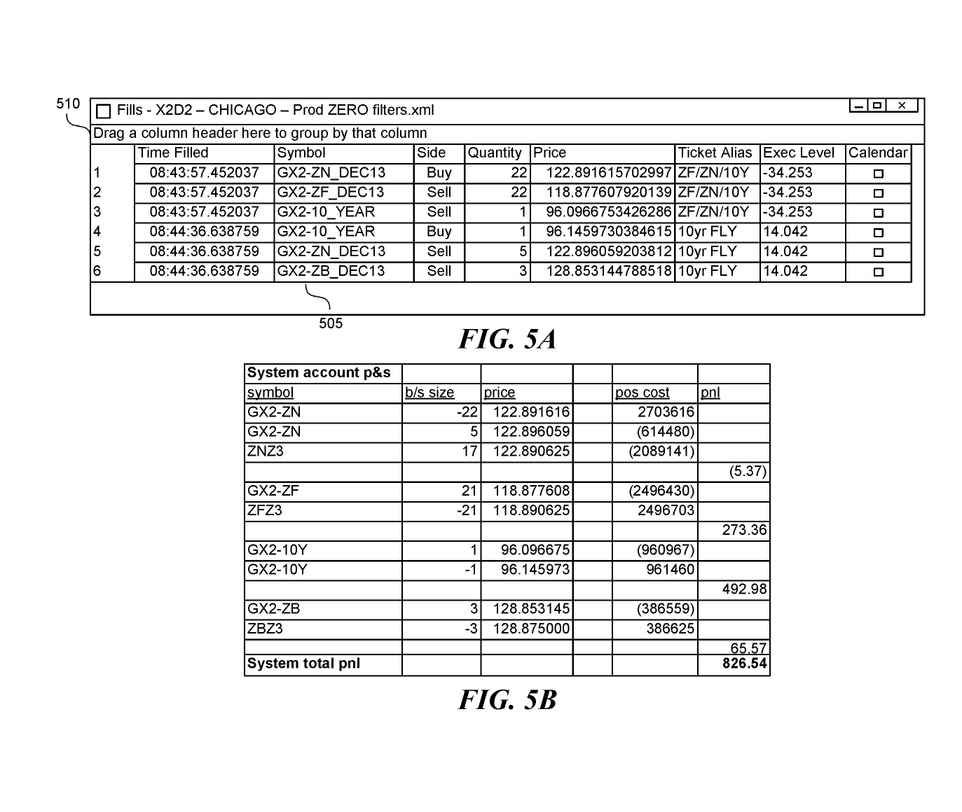

When a spread order is executable based on the price level, but the desired quantity is greater than that shown by the system, a partial fill may be generated for the trader. Each partial fill of a spread order still includes all the legs in the defined ratios of the spread order. For example, an order to buy a total of 50 of a 3 Year/5 Year treasury spread (buy 50 3 Years and sell 30 5 Years) can be partially filled as 25×15 but always in balance including both legs in the 1 to 0.6 ratio. Once an order for a spread is completely filled based on the total desired quantity, the described technology consolidates risk proxy fills into a single fill using, for example, cash treasuries, Exchange of Futures for Physicals (EFP), and/or Exchange For Futures (EFF), in the case of spreads comprised of those instruments, and always in full accordance with exchange and regulatory rules. The technology can use a multitude of other methods to effect this synthetic risk transfer depending on the markets traded, other users' orders, and synthetic risk proxies can be created to manage this transfer. Additional information relating to these features can be found in the Figures, such as in FIGS. 5-10.

In some embodiments, the described technology receives spread or portfolio information including a target value between a bid price and an ask price for trading one or more market assets. The described technology can determine a fulfillment value at which to fill a spread or portfolio for the one or more market assets, based on the target value, a determined bid price, and a determined ask price for trading the spread or portfolio at a value substantially equal to the fulfillment value. The fulfillment value is sent for display to a trader who, if he or she wants the spread at the fulfillment value determined by the system, accepts the spread or portfolio at the fulfillment value. At this point the risk of execution of the spread may pass from the trader to the described technology, which executes the necessary components of the spread at the best possible price. The described technology executes the spread or portfolio at the determined bid price and the determined ask price; therefore, there is little to no risk of non-execution of all the legs of the spread or portfolio.

In other cases, any difference between the fulfillment value and the executed value may remain at the trader. Still yet, in some embodiments, other risk structures may be implemented. For example, the described technology may use a collared risk structure that places a range or collar outside of which the cost difference passes to the described technology. Additional information relating to these features can be found in FIGS. 5-10, and as described herein.

The described technology, in accordance with various embodiments, may be a platform including one or more client-side devices, each having a graphical user interface (GUI) component that displays features that allow a trader to view, input, create, and otherwise manipulate data to facilitate trading spreads and other financial data. The client-side devices communicate with a trading desk platform or server having one or more execution components, risk management components, and client components that generate revenue primarily by taking principal risk. (Principal risk generally relates to transferring, to the system of execution, the profit or loss that results from the difference between the guaranteed price and executed price—thus, revenue may be generated by the system when it ultimately fills the spread better than the guaranteed price or finds efficiencies with other orders it is working from in other requested spreads, or a loss may be incurred if the system cannot execute the spread at a price better than the price guaranteed to the trader.)

The platform may be used by the trader to “guarantee” that the trader's execution risk is transferred away from the trader to the trading firm that operates various features of the described technology. For example, a trading firm (and/or other financial institution) and a trader can use the described technology to analyze financial markets based on the trader's desired spread construction and target price.

The described technology can provide a live, streaming bid price and offer price at which the described technology can guarantee (or provide some likelihood of) execution of that spread. Once the trader agrees to accept the price of a spread, the trade is filled at that price, and the execution risk associated with the fill may be assumed (partially or fully) by the described technology which bundles the legs of the spread together, enters the market, and executes the spread at the best possible price, which may be better or worse than the price at which the trade is filled. Thus, the system presents to a trader via the GUI (or via an API) a live updating of prices obtained from the electronic markets (though modified as noted herein), so that little noticeable delay occurs (e.g., a trader can see prices and execute trades with delays from actual electronic market prices that are well under five seconds).

The described technology can quickly customize an index, portfolio, or spread value based on internal risk proxies. In accordance with various embodiments, internal risk proxies can be implemented as a synthetic instrument representing a position that the system inherits at the time of execution risk transfer “ERT”. Traders receive fulfillment values while the system receives the opposite side (in both position and price) of the trader's fulfillment values. These synthetic products are then managed and offset by with actual products on the exchanges or inter dealer brokers.

Spreads, indices, and portfolios are alternate ways of describing a simultaneous execution of a basket including multiple products (e.g., legs, components, members, etc.), and various embodiments of the present technology may interact with some or all of these products. For example, some embodiments of the described technology can stream actionable prices and sizes in a custom-defined spread. Once the described technology generates a fill on a ticket for a spread, the system may automatically and algorithmically execute each of the individual instruments that are included in this custom spread as independent legs across one or more exchanges or liquidity pools. In accordance with some embodiments, the described technology allows a trader at a trading client user-interface (and/or API) to quickly select, combine, and weight individual risk proxies to construct custom spreads.

As noted herein, the system can provide pricing for multi-legged spreads as decimalized prices for a financial instrument based on use of internal risk proxy instruments to decimalize and present streaming, actionable markets (e.g., at least one ask and one buy for a number of instruments). These risk proxies can be used for internal performance tracking of the firm's traders. For example, certain financial instruments are traded in increments (“ticks”) of a full point (e.g., 1/32, 1/64, or 1/128). The described technology can, in some embodiments, convert these prices into decimals, which allows for multi-legged spreads to be priced with greater granularity than if only standard tick sizes are used. When the technology is deployed in a trading firm with a common account ownership, for example, these risk proxies may be used as internal accounting entries to track a trader's performance. The firm can manage the underlying position in the instruments that are executed on the external electronic market, but yet the firm has the ability to account for each trader's individual performance while consolidating overall order flow at the firm level or at a pre-determined grouping within or outside the firm.

Various embodiments can provide prices for each of the instruments that are included in the defined spread. These prices can be used to provide (guaranteed) levels to the user. In order to produce values for these prices, the system uses risk proxies to adjust prices to levels different than those in the underlying instruments in the electronically traded markets. The system classifies the underlying markets into various states such as stable, stable but not satisfying a minimum quoted quantity, and unstable. These states along with the underlying market price levels are used to determine the prices that are quoted in the Risk Proxy prices (as defined herein).

Each update in price or in liquidity in the underlying instrument is used to evaluate the latest quote in the Risk Proxies, described herein. The described technology has access to all working spread orders within a system and can use the decimalized prices for individual legs as represented by the risk proxies in order to make decisions on when to generate a fill for each working spread order.

Some embodiments of the described technology can also mitigate risks associated with “wash sales.” Federal regulations and exchange rules prohibit wash sales, which may occur when the same beneficial owner of a trading account places buy and sell orders for the same financial instrument at or about the same time and at the same price without the intent to expose the position to market risk. For certain entities, including proprietary trading firms and trading desks of broker dealers, the appearance of wash sales may occur when different traders within those entities place buy or sell orders in the same financial instrument even though the traders have no knowledge of each other's orders nor the lack of intent to expose the position to market risk.

Regulators and exchanges have increased their scrutiny of this activity, however, and the “intent” component of a wash sale violation, among other components of this violation, may create a grey area that is difficult to prove or disprove. In some embodiments, the described technology can determine a single point of execution per traded instrument for an entire firm or omnibus account. This consolidates together the interests of competing firm algorithms and firm inventory for optimal execution and risk management, and only sends to the marketplace the orders needed to complete the net orders of the firm instead of sending multiple orders from different traders within a firm.

Various embodiments of the technology will now be described. The following description provides specific details for a thorough understanding and enabling description of these embodiments. One skilled in the art will understand, however, that the described technology may be practiced without many of these details. Additionally, some well-known structures or functions may not be shown or described in detail, so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the technology. Certain terms may even be emphasized below; however, any terminology intended to be interpreted in any restricted manner will be overtly and specifically defined as such in this Detailed Description section.

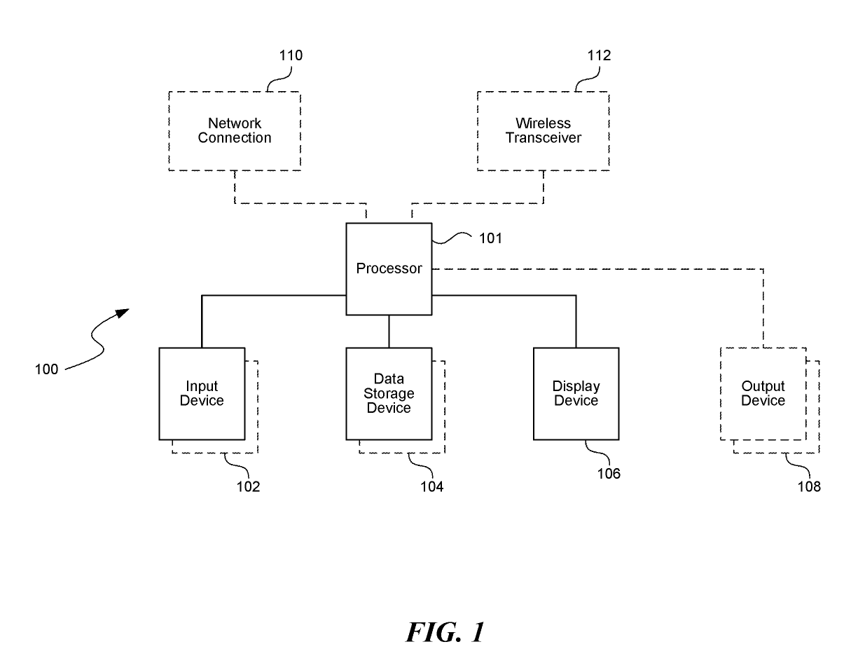

FIG. 1 and the following discussion provide a brief, general description of a suitable computing environment in which aspects of the described technology can be implemented. Although not required, aspects of the technology may be described herein in the general context of computer-executable instructions, such as routines executed by a general or special purpose data processing device (e.g., a server or client computer). Aspects of the technology described herein may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the technology may be distributed over the Internet or over other networks (including wireless networks) on a propagated signal on a propagation medium (e.g., an electromagnetic wave(s), a sound wave, etc.) over a period of time. In some implementations, the data may be provided on any analog or digital network (packet switched, circuit switched, or other scheme).

The described technology can also be practiced in distributed computing environments, where tasks or components are performed by remote processing devices, which are linked through a communications network, such as a Local Area Network (“LAN”), Wide Area Network (“WAN”), or the Internet. In a distributed computing environment, program components or sub-routines may be located in both local and remote memory storage devices. Those skilled in the relevant art will recognize that portions of the described technology may reside on a server computer, while corresponding portions reside on a client computer. Data structures and transmission of data particular to aspects of the technology are also encompassed within the scope of the described technology.

Referring to FIG. 1, in some embodiments, the described technology employs a computer 100, such as a personal computer, workstation, tablet, or smart phone, having one or more processors 101 coupled to one or more user input devices 102 and data storage devices 104. The computer is also coupled to at least one output device, such as a display device 106 and one or more optional additional output devices 108 (e.g., printer, plotter, speakers, tactile or olfactory output devices, etc.). The computer may be coupled to external computers, such as via an optional network connection 110, a wireless transceiver 112, or both.

The input devices 102 may include a keyboard, keypad, touch screen, and or a pointing device, such as a mouse. Other input devices are possible, such as a microphone, joystick, pen, game pad, scanner, digital camera, video camera, and the like. The data storage devices 104 may include any type of computer-readable media that can store data accessible by the computer 100, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network, such as a local area network (LAN), wide area network (WAN), or the Internet (not shown in FIG. 1).

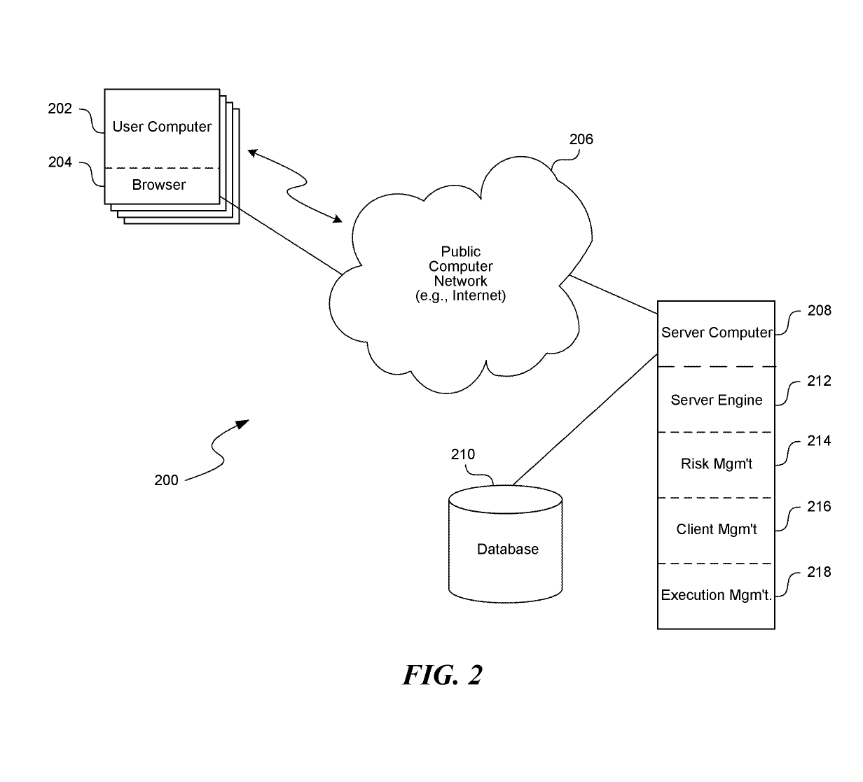

Aspects of the described technology may be practiced in a variety of other computing environments. For example, referring to FIG. 2, a distributed computing environment with a web interface includes one or more user computers 202 (e.g., mobile devices) in a system 200, each of which includes a browser program component (e.g., a thin client component) 204 that permits the computer to access and exchange data with the financial resources, including servers, trading firms, financial exchanges, market data platforms, and or web sites within a LAN or the World Wide Web portion of the Internet. The user computers 202 may be substantially similar to the computer described above with respect to FIG. 1. User computers 202 may be personal computers (PCs) or mobile devices, such as laptops, mobile phones or tablets. The user computers 202 may connect to the Internet 206 wirelessly or through the use of a wired connection. Wireless connectivity may include any form of wireless technology, such as a radio access technology used in 2G/3G/4G or other mobile standards.

User computers 202 may include one or more client-side software components (e.g., software, a GUI, and or hardware) to facilitate trades and other data transactions with at least one or more of the various financial services mentioned above. User computers 202 may include other program components, such as an operating system, one or more application programs (e.g., word processing, spread sheet applications, or Internet-enabled applications), and the like. The computers may be general-purpose devices that can be programmed to run various types of applications, or they may be single-purpose devices optimized or limited to a particular function or class of functions. More importantly, while shown with web browsers, any application program for providing a graphical user interface to users may be employed, as described in detail below; the use of a web browser and web interface are only used as a familiar example here. For example, a mobile application or “App” has been contemplated, such as one used in Apple® iPhone® or iPad® products, Microsoft® products, Nokia, or one used in Android®-based products.

At least one server computer 208, coupled to the wired and or wireless LAN, WAN, Internet, or World Wide Web (“Web”) 206, performs some or all of the functions for receiving, routing and storing of electronic messages, such as electronic trades, financial communications, financial data, alerts, web pages, audio signals, and electronic images. While the Internet is shown, a private network, such as an intranet, may indeed be preferred in some applications. The network may have a client-server architecture, in which a computer is dedicated to serving other client computers, or it may have other architectures, such as a peer-to-peer, in which one or more computers serve simultaneously as servers and clients.

A database 210 or databases, coupled to the server computer(s), stores many of the web pages and content exchanged between the user computers. The server computer(s), including the database(s), may employ security measures to inhibit malicious attacks on the system and to preserve integrity of the messages and data stored therein (e.g., firewall systems, secure socket layers (SSL), password protection schemes, encryption, and the like).

The server computer 208 may include a server engine 212, a risk management component 214, a client management component 216, and an execution management component 218. The server engine 212 performs basic processing and operating system level tasks. The risk management component 214 handles creation of electronic trades, risk calculations, and or determinations and other features included in the various embodiments therein. Traders may access the server computer by means of one or more network protocols (not shown), such as TCP/IP associated therewith. The client management component 216 handles most of the functions sent to and received from the trader and various embodiments described herein. The execution management component 218 includes storage, retrieval, and execution tasks that, alone or in combination, determine, for example, pricing, spread level fill data, proxy data, etc. In some embodiments, multiple server computers 208, each having one or more of the components 212-218, may be utilized.

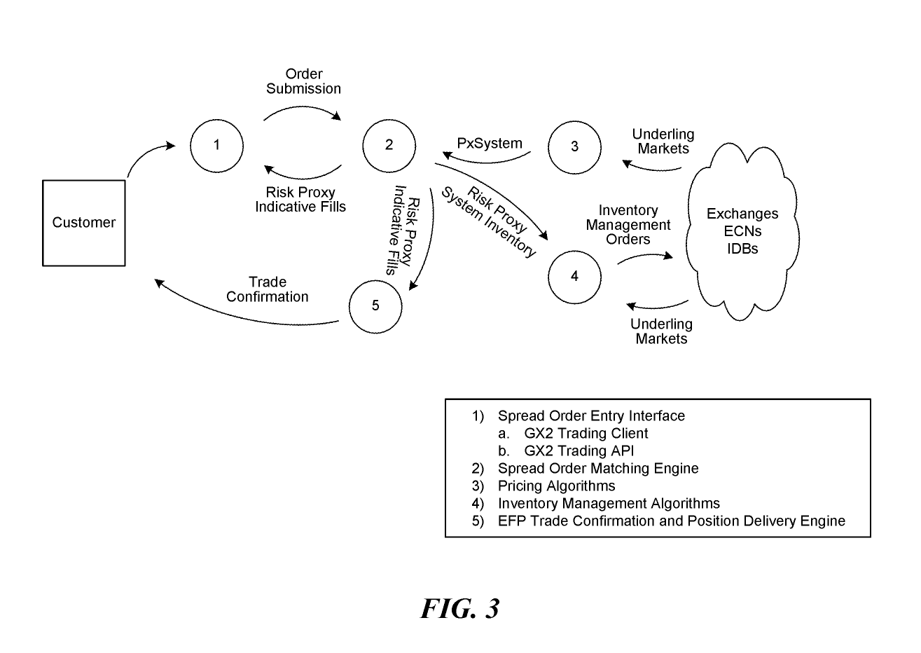

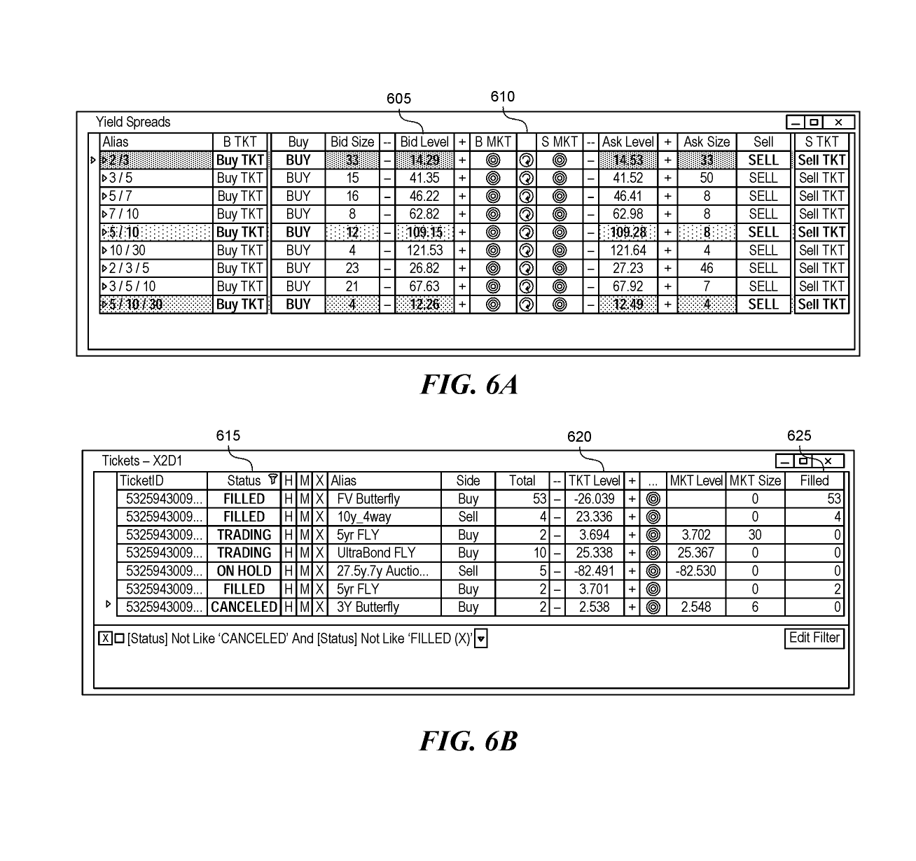

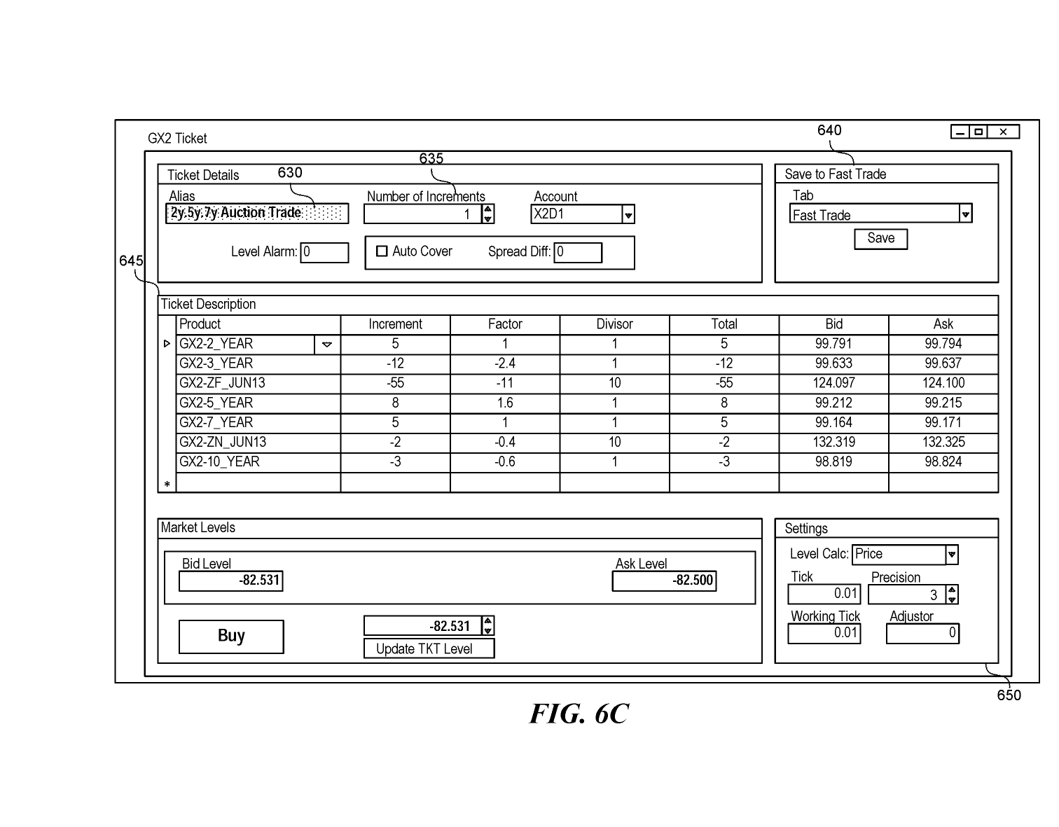

Referring to FIG. 3, a set of components that may be used in accordance with various embodiments of the present system are shown. As shown, the system includes a Spread Order Entry Interface (1) (see, e.g., FIG. 6C) that includes the Trading Client and Trading API described herein. The system can also include a Spread Order Matching Engine (2), Pricing Algorithms (3), and Inventory Management Algorithms (4). Furthermore, the system includes an Exchange for Physical (EFP) Trade Confirmation and Position Delivery Engine (5) or other trade confirmation engine for other instruments.

Spread orders are defined (and optionally saved to a workspace) by the trader and submitted using the Spread Order Entry Interface (1), which is shown and described in greater detail in the Figures. Upon submission by the trader, spread orders, in some embodiments, are held at an electronic central limit book (explained below), which is accessible to the Spread Order Matching Engine (2). The Spread Order Matching Engine (2) can evaluate when electronic spread data structures or tickets will be executed based on prices and sizes/amounts generated by the Pricing Algorithms (3), as described below. Once all of the legs of a spread order can be fulfilled according to the Pricing Algorithms (3), the Spread Order Matching Engine (2) generates an indicative fill for the trader using the Risk Proxies and issues a change in inventory instruction to the Inventory Management Algorithms (4). The indicative fill may be a data structure and/or message for a trader to indicate that the spread has been filled, even though the actual electronic trade has yet to occur.

In general, the system may employ a spread level calculation for a typical spread, such as:

SPREAD PRICE=PRICE_LEG1*(FACTOR1/DIV 1)+PRICE_LEG2*(FACTOR2/DIV 2)+PRICE_LEG3*(FACTOR3/DIV 3)+ . . . .

Where:
PRICE_LEG$=the price of the Risk Proxy that is produced by the system
FACTOR$=represents the trading ratio between LEG1 and LEG$
DIV$=a divisor used to equate the different notional amounts, point values, native currencies, etc.

Risk Proxies may be used by the system to represent accounting entries that can be used by a firm for performance tracking of its traders or portfolio managers. Risk Proxies are used by the system to represent a price and quantity available to fulfill the included legs of a spread order. When a spread order is fulfilled, the trader receives an indication of a fill when the system provides or delivers to the trader a Risk Proxy price and quantity. Simultaneously the system receives notification of an opposing position in the Risk Proxies. This notification identifies a change in inventory for the system. The system issues an instruction triggered by this change in inventory under the Inventory Management Algorithms (4).

The Inventory Management Algorithms (4) can manage the orders and prices posted on the exchange in the underlying instruments to reduce the system inventory to a desirable position. The desired position of the system may be that of zero position or the desired position of the system may be to maintain a stable position that includes correlated or co-integrated members of a portfolio. The desired position is not a unique solution and can vary from one system implementation to another.

The indicative fills are converted to positions in exchange traded products using the EFP Trade Confirmation and Position Delivery Engine (5). Thus, after the trader receives indication that the spread has been filled, the EFP Trade Confirmation and Position Delivery Engine (5) actually executes each leg of the spread on one or more electronic markets. Note that EFP is not used in every type of spread execution by the system or in every type of implementation of the present technology. For example, one implementation may not require EFP because the system is deployed within a proprietary firm with common account ownership, but if a firm had external customers it would typically employ the EFP process on certain instruments to deliver the fills.

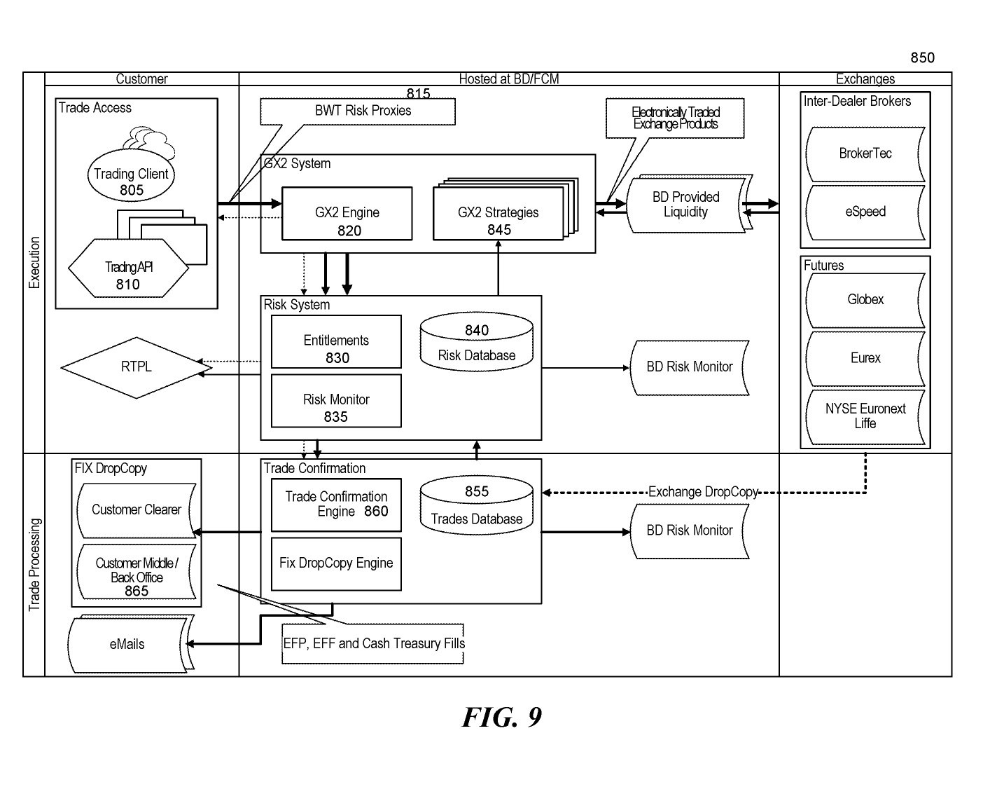

In a Broker Dealer system implementation (see, e.g., FIG. 9), the system may use EFP's to deliver fills to customers when a futures leg is included in a spread definition. The system may use a “Give-Up” of the exchange executed futures to the customer of a Broker Dealer, which could reduce overall execution costs and expand the set of possible spreads that could be defined in the system (e.g., futures versus futures spreads). (A give-up is a trading procedure where an executing trader/broker places a trade on behalf of another trader/broker as if he or she actually executed the trade, and the trade is not actually recorded as being executed by the executing trader/broker.) In accordance with various embodiments, any regulatory-compliant method may be utilized by the system to efficiently deliver fills.

Detailed descriptions of certain components can help provide a further understanding of aspects of the system. The Pricing Algorithms (3) draw together information from the underlying exchange-traded or inter-dealer broker markets to decimalize, tighten, and appropriately size the liquidity presented to fulfill the guaranteed spread levels to traders using the disclosed system. The pricing algorithms form a fair market decimalized price for each instrument that may be traded in the system. This market (e.g., a fair market) may be based on an inverse liquidity weighting using, for example, the following formulation:

P_{fm}=(S_{b}*Pₐ+Sₐ*P_{b})/(S_{b}+Sₐ)
Where:
P_{fm}—Fair Market Price
Pₐ—Ask Price in the underlying market
P_{b}—Bid Price in the underlying market
Sₐ—Ask Quantity in the underlying market
S_{b}—Bid Quantity in the underlying market
P_{bsystem}—Bid Price of the system
P_{aystem}—Ask Price of the system
S_{asystem}—Ask Quantity of the system
S_{bsystem}—Bid Quantity of the system
Sₐₘₐₓ—Maximum Ask Quantity of the system
S_{bmax}—Maximum Bid Quantity of the system
φ—liquidity factor, defined as a percentage of the liquidity in the underlying market instrument. For example, a 10 Year cash treasury may show liquidity as 38 mm (million) on the top of book best bid. A liquidity factor equal to 75 would imply a quote in the Risk Proxy of 28 mm liquidity on the indicative best bid level.

Once the system calculates P_{fm}, it can generate an effective system bid and ask price as well as a system bid and ask quantity. Factors that the system can consider to derive these system bid/ask prices and quantities include:
Fixed decimalized price spread from the P_{fm}
Fixed limits for P_{bsystem} and P_{asystem} in relation to the underlying market P_{b} and Pₐ

For example, a Quote 1 for instrument X

| bid qty | bid price | ask price | ask qty |
|---|---|---|---|
| 100 | 99.15 | 99.16 | 100 |

Quote 2 for instrument X

| bid qty | bid price | ask price | ask qty |
|---|---|---|---|
| 100 | 99.12 | 99.19 | 100 |

In the example above, both markets have the same Fair Market Price of 99.155. The spread from P_{fm} would provide the same quote in the Risk Proxies. Only the Fixed limits for P_{bsystem} and P_{asystem} would widen the market in the Risk Proxies in the second underlying market quote. If the fixed limit were set to 0.015, the market in the Risk Proxy would be 99.135 bid 99.175.

The system can apply the above algorithm to account for three different states for each leg of a spread: stable, stable but does not meet minimum quoted size in the underlying market, and unstable. Based on the particular application or trading philosophies of a firm, the variables of the algorithm may be modified as desired to account for the three different states. For example, the difference between stable and unstable may be the length of time the price remains stable for a particular product. In general, unstable represents a moving price for one or more legs in the spread. To price individual risk proxies, the system looks at the state, the bid and ask prices and liquidity for each leg. More specifically, the system may consider:
The stability or volatility of price changes. The system may impose a hysteresis on price changes in the direction of the market that ends once price stability is established.
System quantities (S_{asystem} and S_{bsystem}) are calculated based on the underlying market quantities. These quantities are calculated using the following formulation.

S_{asystem}=min(floor(φ*Sₐ),Sₐₘₐₓ)
System inventory is also taken into account for the system quantity. For example, S_{asystem} is decreased and S_{bsystem} is increased when the system holds a short position in the underlying instrument.
The system can quote a guaranteed minimum size by looking to the depth of the market to calculate both system price and quantity. If floor (φ*Sₐ)<1, a zero quantity would be quoted. This secondary quantity algorithm examines the prices and quantities available away from the best bid or offer (BBO) to generate a defined Sₐₘᵢₙ.

Fulfilling traders' spread orders generates system inventory (i.e., some position held by the system's account in the traded instruments). This inventory is managed by the Inventory Management Algorithms (4) and can be located on computers at the closest possible proximity to the exchange the underlying instrument is trading on (e.g., for optimal execution, processes or algorithms described herein can reside on a computer co-located at an exchange matching engine to minimize latency). An exchange co-location is usually preferred when available. The Inventory Management Algorithms (4) are triggered to bring the position of the system to a desirable level (e.g., a best price). Factors that affect the decision to trigger an Inventory Management Algorithm can include:
Instruments are treated individually and the best execution decision is made without regard to other positions held by the system.
Ratio between the available liquidity on the bid and the ask of the underlying instrument.
Ratio of the size of the system inventory and the available liquidity on the opposite side of the market of the underlying instrument.
Pricing consideration that keep prices of orders equal to the prices on the top of the book best bid or offer (BBO). In other words, the orders for the system are placed at the most competitive prices in the market. If the market moves away from these prices, orders are adjusted to the new prevailing best bid or offer BBO.
Current values and dynamics of market variables are used to control aggressiveness of the inventory management algorithms.
Extensions to inventory management include evaluating the system inventory and making adjustments to the most stable overall portfolio in order to increase the holding time of positions.

In general, the system attempts to execute the spread at the “best” possible price. Determining the best possible price can take into account one or more of the above-noted factors. The best price typically is an optimal price as defined by one or more inventory management algorithms. The Inventory Management Algorithms (4) can take into account both price and liquidity for each product bought/sold. The Inventory Management Algorithms (4) may not consider time or price relative to the entry time or price of the legs when entering the market.

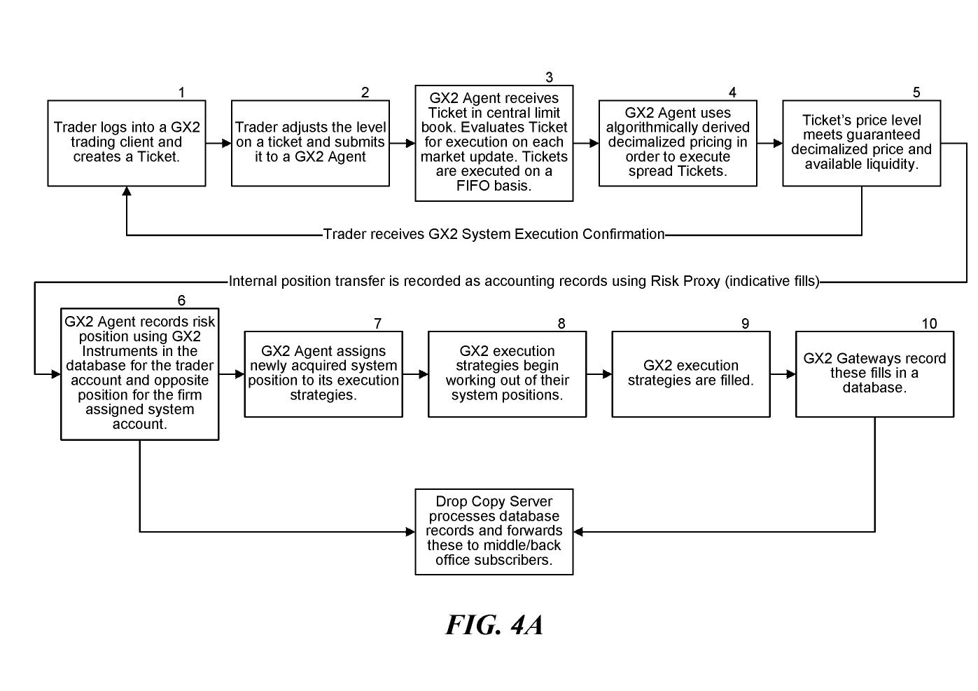

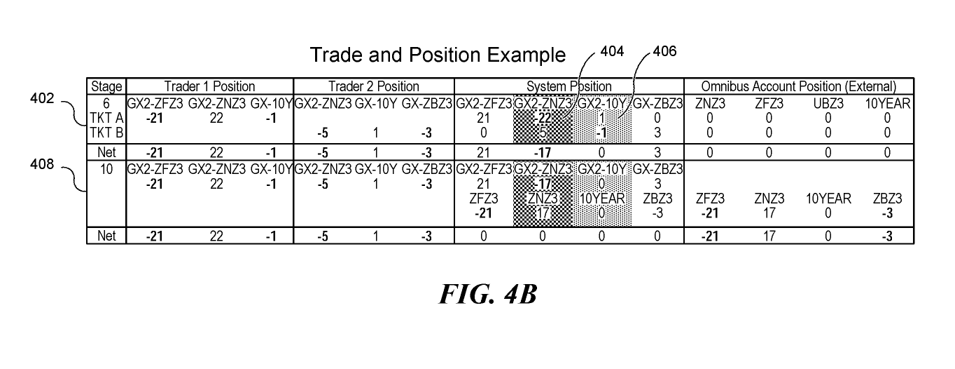

An example of a suitable system trade flow is shown in FIG. 4A. The flow begins in block 1 where a trader logs into a trading client residing on a computer associated with the trader (or an associated API logs in) and creates a ticket, which represents the desired spread created by the trader. At block 2, the trader can adjust the ticket level (e.g., by increasing or decreasing a price that the trader is willing to bid/sell an instrument and/or the quantity of the spread desired) (see, e.g., FIG. 6C) and submit the ticket to a Spread Order Matching Engine.

At block 3, an entry for each ticket is recorded in an electronic central limit book, which is a repository that stores received tickets in a format from, for example, the highest bid ticket down to the lowest order ticket. With each update to the market, the Spread Order Matching Engine and/or other components, evaluates tickets in the central limit book for execution upon each market update.

At block 4, the Pricing Algorithms, and/or other features/components, use algorithmically derived decimalized pricing in order to execute spread tickets. For example and as explained above, to increase precision and granularity when calculating spreads, a decimalized version of an instrument is associated with the fraction used in the market to represent that instrument.

At block 5, when the Pricing Algorithms, and/or other features/components, determine that the ticket price level meets a guaranteed decimalized price and available liquidity, the trader is sent a confirmation that his/her ticket is fulfilled. At block 6, the Inventory Management Algorithm, or other feature/component, accounts for internal risk by recording (e.g., in a database) the position entry for the trader and an opposite position entry for the firm assigned system account.

At block 7, Inventory Management Algorithms, or other features/components, use the newly acquired trade positions in its execution strategies so that, at block 8, one or more new execution strategies can be developed and executed, at block 9, to fulfill a market order for the internal system. At block 10 the market order fills are recorded in a database. Database records, from block 6 and block 10, in some embodiments, are made available to other components/market entities (e.g., middle/back office subscribers) for accounting and other purposes.

Note that the system may not execute all or any of the spread legs in the market, particularly if it has opposing orders by other users and can just net them out. An example of this is shown in FIG. 4B, where Trader A creates a spread associated with Ticket A, while Trader B creates Ticket B, shown in the first row 402. These tickets are created or recorded under block 6 of FIG. 4A (as represented in the column “Stage”). In the example shown, Trader A shorts future ZF at −21 and 10Y cash at −1, but buys ZN at 22. Trader 2 executes the second position represented by Ticket B concurrently as shown. Note that each of these products are shown with a prefix “GX2”, which represents an internal dissemination or data structure used by the system. (The suffix “Z3”, for example, refers to expiration code for the product.)

As shown in the System Position column, the system determines a net position, in this example, between Ticket A and Ticket B. With respect to the security ZN shown in column 404, the −22 for Trader 1 combines with the 5 for Trader 2 for a net −17 that the system must execute with actual exchange traded contracts. But for the 10Y, the −1 for Trader 1 and 1 for Trader 2 net to 0 as shown in column 406, and thus the system need not make any actual trade on the electronic market. The system mitigates any perception of a wash sale by aggregating these internal trades as noted herein.

As shown in the Omnibus Account Position (External) column, the system shows that the system achieves a desired position (zero position) for the position of all traders in row 402. Note that the System Position reflects the opposite position taken by the system after aggregating all of the tickets from the different traders (which in this simple case was only 2). Thus, as shown in row 408, the system converts the internal commodity GX2-ZNZ3 at −17 to an actual commodity ZNZ3 at 17, which represents an actual trade on the electronic market of purchasing the commodity ZNZ3 at 17, where the actual purchase is shown in row 408 in the Omnibus Account Position (External) column.

FIG. 5A shows an example of a GUI or API employed by the system to represent each Trader's transaction and shows fills as “guaranteed” by the system for the example of FIG. 4B. In accordance with some embodiments, a trader can drag a symbol heading in symbol column 505 to the group by box 510 which will cause the orders to be rearranged so that all fills are grouped by symbol. This allows the user to see the net position for all filled products as well as the average fill price and the average executed level. FIG. 5B shows an example of a screen or data structure representing the system executing the spreads for the two Traders via the actual exchange traded contracts and the resulting profit and loss (pnl). In the example, the system lost 5.37 on the ZNZ3 leg, but earned 492.98 on the 10Y.

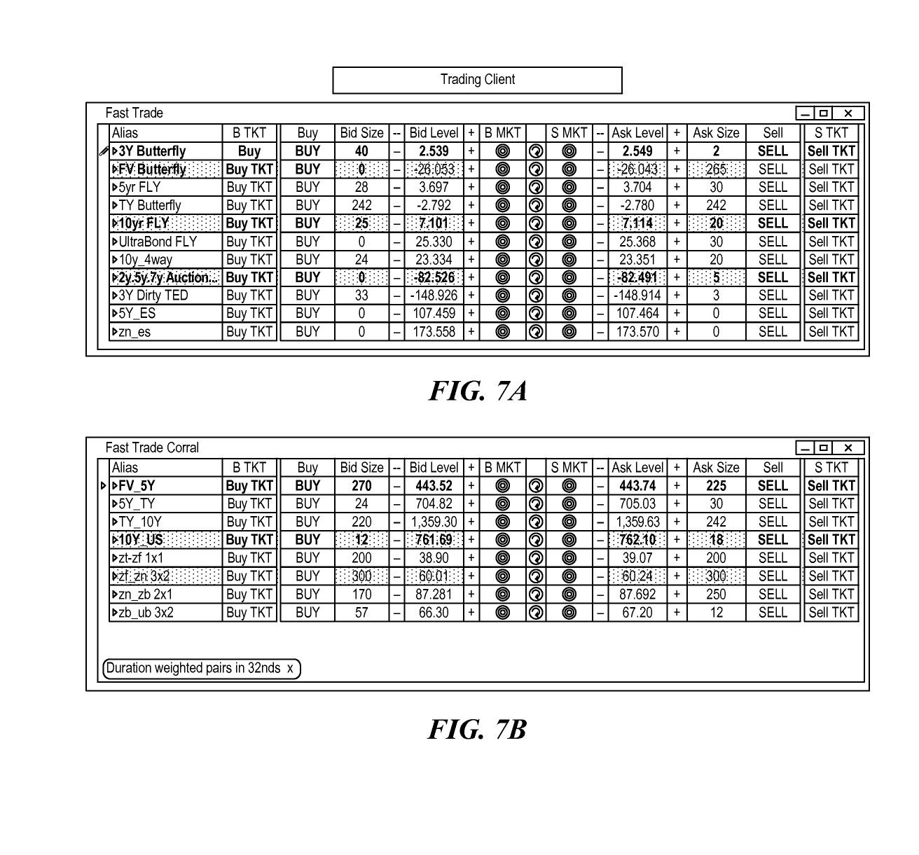

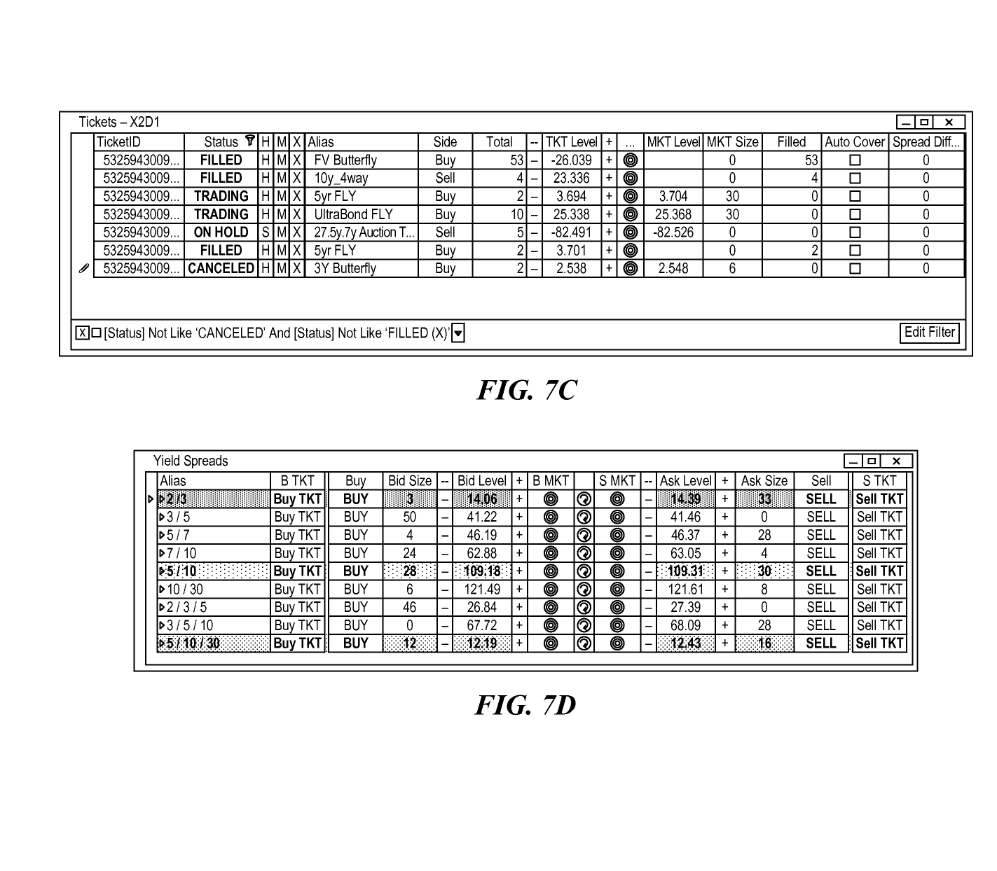

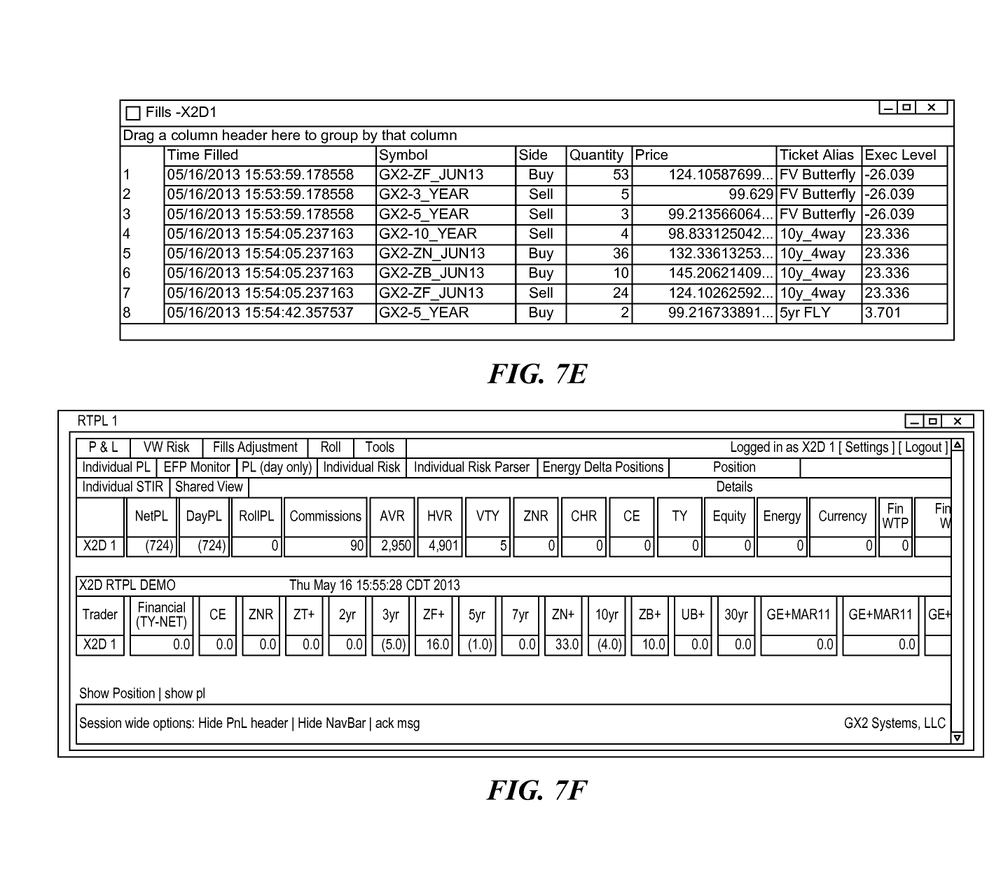

FIGS. 6A-6C and 7A-7F are examples of various display screens that may be used by one or more embodiments of the present technology. For example, FIG. 6A illustrates a fast trade window of customized strategies that can be set by a trader and a limit order book for managing strategy execution. These trading strategies can be set and then quickly executed by selecting the buy TKT or sell TKT buttons. Similarly, the trader can buy or sell individual lots. Before submitting spread orders, the bid level column entries 605 can be edited to allow a user to modify bid levels. The buttons in column 610 can allow the user to reset the bid and ask level to the current market levels.

FIG. 6B illustrates a display screen with a limit order book for managing strategy execution. This display screen allows the trader to see the status of submitted order tickets, working ticket levels, and filled quantities. Status column 615 shows the current status (e.g., on hold, trading, canceled, filled, etc.) of the ticket.

Ticket level column 620 shows the working ticket level and filled column 625 shows the filled quantity of the first leg. In some embodiments, additional columns may be present that allow the user to select the autocover functionality. When the autocover functionality is active, for each primary filled spread ticket the user receives, a closing or covering spread is placed automatically. This covering ticket is placed at a user defined price distance away from the primary filled spread ticket.

If autocover is engaged, an identical ticket of the opposite side will be submitted when the initial ticket is filled. The level of the “Cover” ticket is the determined by the Ticket Level Diff set on the initial ticket (e.g., If you're working a buy ticket at the level 100.00 with autocover engaged and a Ticket Level Diff of 1.00, when the buy ticket is filled a Sell ticket will be submitted at the level 101.) This process will continue until the user disables the autocover feature (e.g., by unchecking an AutoCover box) on the working ticket.

FIG. 6C illustrates an example of a display screen that may be used to enter order tickets for multi-legged strategies that can be created by the trader. As illustrated in FIG. 6C, alias component 630 can be used by the trader to enter a nickname that will make finding the ticket easy for the trader. Increment component 635 allows the trader to select the number of individual increments to be filled. Fast trade component 640 can allow the user to save the ticket to a fast trade screen (e.g., FIG. 6A) within the trading interface.

As illustrated in FIG. 6C, ticket description component 645 can include a table or other interface that allows the user to create the multi-legged trading strategy. Calculation component 650 allows the trader to select the level of calculation. FIGS. 7A-7F illustrate other variations of the trading interfaces once the customized spread orders have been created. In accordance with various embodiments, the system allows a trader to use a variety of features and orders types using these and other graphical user interfaces.

One example of an order type that can be created in some embodiments is the one cancels other (OCO) order. In an OCO order, any ticket that is filled in a group will cancel the other tickets in the group. In some embodiments, a user can select (e.g., right-click) rows on a graphical user interface to assign tickets to an OCO group. Tickets that are not completely filled or canceled can be put in OCO groups. A ticket can belong to only one OCO group at a time. To add a group of tickets to an OCO group, a user can select the tickets in the Spread Tickets window (e.g., use ctrl+click to select a discontinuous set or shift+click to select a continuous set) then right click and select “Add selected tickets to new OCO group”. If one of the tickets selected already belongs to an OCO group the trader may be presented with the option of adding all the selected tickets to that OCO group or to add them all to a new group. Tickets can also be put into OCO groups via the ticket entry dialog by modifying the ticket and then changing the OCO Group ID dropdown.

Another example of an order ticket that the system allows the user to create is the Stop Limit Ticket. The stop limit ticket will be triggered at the Stop Trigger Level and become a limit ticket at the Limit Level specified. The Limit Level Diff allows the user to use the up/down arrows to adjust the level and maintain the difference between the Stop Trigger Level and the Limit Level. Max Spread is the maximum difference between the market bid ask allowed to trigger the stop. For example, in the event of an economic number where markets may widen temporarily, the stop will not trigger if the bid ask spread is larger than the amount indicated in the Max Spread field. Setting the field to blank or “Infinity” may disable this feature in some embodiments.

OCO Stop Limit can be enabled using the graphical user interfaces (e.g., by checking an OCO Stop Limit box). Enabling this feature will create a Stop Limit cover ticket as well as the Limit cover ticket mentioned above. The Stop limit ticket can have a trigger level determined by execution level of the initial ticket+/− (depending on side) the Stop Trigger Level Diff specified. The limit level of the ticket can be the stop trigger level+/− the Limit Level Diff. Finally, the Stop Limit ticket may have the Max Spread value specified in the Max Spread field.

In some embodiments, the graphical user interface screen may present the guaranteed market prices for the spread order along with the prices that are available through the markets where the user would take the execution risk. The user can then evaluate the cost difference and determine whether that difference is worth the elimination (or mitigation) of the execution risk. In some embodiments, the user may be able to set automated trading strategies that automatically select between the guaranteed market prices and the prices that are available through the markets where the user would take the execution risk.

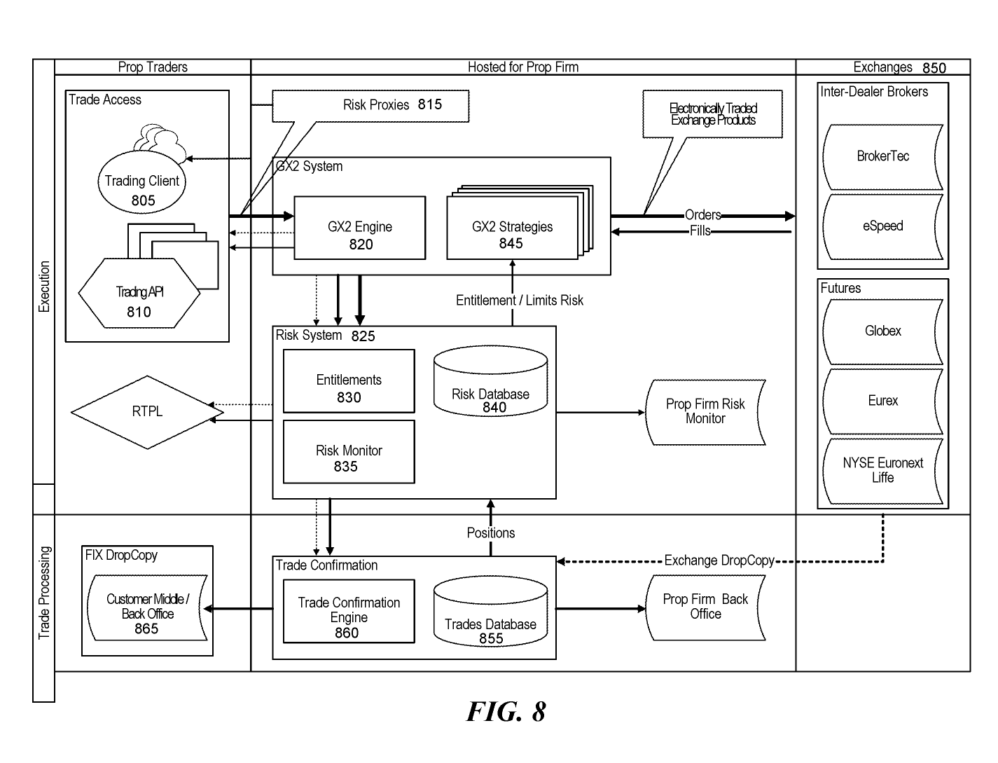

FIGS. 8-9 are block diagrams illustrating various components of various system configurations of some embodiments of the present technology. As illustrated in FIGS. 8 and 9, trading client 805 or trading API 810 can be used to generate spread orders. In accordance with various embodiments, trading client 805 can reside on a computer associated with the trader or may be a thin client that is accessed via a website. The spread orders are translated into risk proxies 815 and are transmitted to system engine 820.

Risk proxies 815 are then submitted to risk system 825 which can use entitlements module 830, risk monitor, 835, and risk database 840 to communicate limits on the spread order. Based on the input from risk system 825, the pricing strategies engine uses algorithmically derived decimalized pricing in order to generate a fulfillment value at which the spread order may be executed. The decimalized pricing can have a granularity greater than those of the underlying market. The information can be transmitted back to trading client 805 or trading API 810 and displayed to the trader. Once the trader accepts the fulfillment value, a spread ticket is created and transmitted back to system engine 820 to execute the spread order using trading strategies 845 on one or more exchanges 850. The trades are stored in trade database 855 and trade confirmation engine 860 generates a trade confirmation that can be transmitted back to other components/market entities (e.g., middle/back office subscribers 865) for accounting and other purposes.

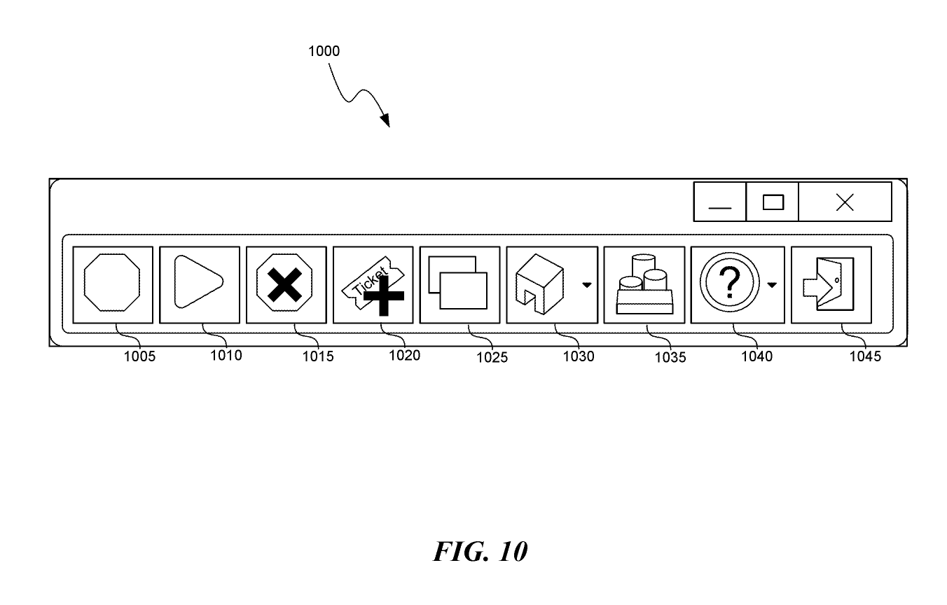

FIG. 10 illustrates an example of a quick action interface 1000 that may be used in accordance with one or more embodiments of the present technology. As illustrated in FIG. 10, stop all button 1005 may be used to place all current working tickets on hold. Start all button 1010 may be used to start all working tickets that are on hold. Cancel all button 1015 may be used to cancel all working and held tickets in a ticket window. New ticket button 1020 may be used to open up a blank ticket template for creating a new ticket.

Fast trade window manager button 1025 may be used to create and manage multiple fast trade windows. Workspace menu button 1030 may be used to open and save workspaces as well as select multiple themes, save and open snap-shot views, and roll instruments. To roll an instrument is to change one or more legs of an existing spread ticket in order to replace an expiring future contract from one that is expires farther out in the expiration schedule. For example, if a trader owns December 14 heating oil and it is going to expire, the system can “roll” it into January 15 heating oil to maintain the trader's position. RTPL button 1035 may be used to open real-time profit and loss (pnl) windows. Help button 1040 may link to various system documentation and help interfaces. Exit button 1045 may be use to close the application.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention. In the event something in a reference contradicts something in this application, this application shall control.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

Certain aspects of the invention are presented below in certain claim forms, but the applicant contemplates the various aspects of the invention in any number of claim forms. For example, while only one aspect of the invention is recited as a means-plus-function claim under 35 U.S.C §112, ¶6(f) (AIA), other aspects may likewise be embodied as a means-plus-function claim, or in other forms, such as being embodied in a computer-readable medium. (Any claims intended to be treated under 35 U.S.C. §112, ¶6(f) will begin with the words “means for”, but use of the term “for” in any other context is not intended to invoke treatment under 35 U.S.C. §112, ¶6(f).) Accordingly, the applicant reserves the right to pursue additional claims after filing this application.

What is claim is:

1. A computer-implemented method comprising:
receiving, at a trading system running on one or more servers, a spread order,
wherein the spread order includes a target value and a desired quantity for purchasing the spread order,
wherein the target value for the spread order represents a price based on a mathematical relationship between an ask price and a bid price for two or more market instruments on an electronic market;
determining, using one or more processors of the trading system, a fulfillment value and a maximum fulfillment quantity at which the trading system will guarantee a fill of the spread order, based on:
the target value, a new bid price, and a new ask price,
wherein the new bid price and the new ask price are real numbers,
wherein the new bid price and the new ask price are determined at least based on a liquidity of the two or more market instruments at a real-time market price, and
wherein the liquidity considers a quantity of the two or more market instruments available at the electronic market at the new bid price or the new ask price;
sending, via a network to a trading client, the fulfillment value and the maximum fulfillment quantity;
receiving, from the trading client, an indication of acceptance to fill the spread order at the fulfillment value; and
filling, in response to receiving the indication of acceptance from the trading client, the spread order at the fulfillment value.

2. The computer-implemented method of claim 1, further comprising sending for display to the trading client a live stream of the ask price or the bid price, or both the ask price and the bid price, and wherein the spread order is guaranteed to be executed in a defined ratio of the two or more market instruments without spread price slippage.

3. The computer-implemented method of claim 1, further comprising:
determining executed prices based on the new bid price or the new ask price at which the spread order was executed; and
insulating a user from a shortfall between the executed price and the fulfillment value when the executed price that does not equal the fulfillment value.

4. The computer-implemented method of claim 1, wherein determining the fulfillment value also includes classifying the two or more market instruments based on trading stability.

5. The computer-implemented method of claim 1, wherein filling the spread order includes charging the fulfillment value and a fee to an account of a user.

6. A computer-implemented method, comprising:
determining a decimalized market representative of multiple market items on one or more live electronic markets, based on a liquidity of the plurality of market items on the one or more live electronic markets,
wherein the multiple market items on the decimalized market are associated with decimalized bid and ask prices and corresponding bid and ask quantities;
receiving an order associated with the multiple market items on the decimalized market, wherein the order is associated with a decimalized fulfillment value based on:
a bid to purchase a specified quantity of one or more of the multiple market items at a price equal to the decimalized bid price, and
an ask to sell a specified quantity of one or more of the multiple market items at a price equal to the decimalized ask price; and
in response to receiving the order:
filling the order at the decimalized fulfillment value, and
causing all or part of the order to be executed, at the live electronic market.

7. The computer-implemented method of claim 6, wherein the decimalized market trades at prices more granular than those available on the one or more live electronic markets.

8. The computer-implemented method of claim 6, wherein the decimalized market is further based on a request received from a user to determine the market for a combination of one or more market items based on the market items on one or more the live electronic markets.

9. The computer-implemented method of claim 6, wherein the fulfillment value is a guaranteed value removing upside and downside execution risk from a user.

10. The computer-implemented method of claim 6, wherein the fulfillment value is a collar removing downside execution risk below a first threshold and upside execution risk above a second threshold.

11. The computer-implemented method of claim 6, wherein filling the order at the decimalized fulfillment value includes:
generating risk proxy fills based on a firm risk profile and the order associated with the multiple market items on the decimalized market; and
consolidating the risk proxy fills into a single fill order.

12. The computer-implemented method of claim 6, further comprising:
generating a graphical user interface having displayed thereon a current status of the order,
providing to all users indications of filled orders,
netting the order against orders received from other users to produce a subset of orders, and
only executing at the live electronic market the subset of orders.

13. A system for implementing electronic trades of instruments at one or more active electronic markets, the system comprising:
means for automatically analyzing the one or more active electronic markets based on a desired spread and target price for a market instrument to determine whether the system will provide a guaranteed offer price for a desired spread;
means for generating and providing to a trader, a substantially real-time bid price and a substantially real-time offer price when the system will generate the guaranteed offer price,
wherein the provided bid price and offer price each include quantities and liquidity at which the system guarantees execution of the desired spread based on the provided bid price and offer price,
wherein the desired spread is associated with at least a desired bid price to sell the desired spread or a desired offer price to buy the desired spread;
means for receiving an indication from the trader to accept one of the substantially real-time bid or offer prices associated with the desired spread;
means for reporting to the trader fulfillment of the accepted bid or offer prices associated with the desired spread,
wherein the reporting of the fulfillment of the accepted bid or offer prices associated with the desired spread is done before all or part of the desired spread is executed at the one or more active electronic markets.

14. The system of claim 13, wherein the trader is one of multiple traders associated with a firm and the system further comprising a means for identifying and consolidating interests of competing firm trades for optimal execution and management by only sending orders needed to complete net orders of the firm.

15. At least one computer-readable storage medium, excluding transitory signals, carrying instructions, that when executed by at least one data processing device, allow a user to purchase or sell assets or commodities available via an electronic market, comprising:
receiving from the user a spread order;
providing to the user a substantially real-time and dynamic display of values associated with the spread order,
wherein any of the real-time and dynamic display of values associated with the spread order are configured to be accepted at the user's option for executing the spread order via the electronic market,
but wherein the real-time and dynamic display of values associated with the spread order represent values automatically converted from actual values obtained from the electronic market;
automatically providing, after receiving an acceptance from the user but before executing a trade via the electronic market, to the user a confirmation that the spread order has been fulfilled,
wherein after providing the confirmation to the user:
a first trade at the bid quantity, and at the bid price or at a better or worse bid price, is automatically executed via the electronic market, and
a second trade at the ask quantity, and at the ask price or at a better or worse ask price, is automatically executed via the electronic market.

16. The at least one computer-readable storage medium of claim 15, carrying instructions, that when executed by at least one data processing device, allow the user to purchase or sell assets or commodities available via an electronic market, further comprising generating a thin client having a graphical user interface that allows the user to create the spread order and present the substantially real-time and dynamic display of values associated with the spread order to the user.

17. The at least one computer-readable storage medium of claim 15, wherein the real-time and dynamic display of values associated with the spread order include a fulfillment value guaranteed to the user.

18. The at least one computer-readable storage medium of claim 15, carrying instructions, that when executed by at least one data processing device, allow the user to purchase or sell assets or commodities available via an electronic market, further comprising determining the fulfillment value at least in part by classifying the assets or commodities associated with the spread order based on a trading stability.

19. The at least one computer-readable storage medium of claim 15, carrying instructions, that when executed by at least one data processing device, allow the user to set limit orders or stop limit orders to automatically enter the spread order.

20. The at least one computer-readable storage medium of claim 15, wherein the real-time and dynamic display of values associated with the spread order are more granular than prices available on the electronic market.
